(19) United States
(12) Patent Application Publication
(10) Pub. No.: US 2011/0011002 A1
(43) Pub. Date: Jan. 20, 2011

(54) SEMI-REMOVABLE WINDOW FRAME ASSEMBLY

(76) Inventor: Christian Guillemette, Beauport (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/893,251

(22) Filed: Sep. 29, 2010

Related U.S. Application Data
(63) Continuation-in-part of application No. 11/653,943, filed on Jan. 17, 2007, now abandoned.
(60) Provisional application No. 60/759,067, filed on Jan. 17, 2006.

(51) Int. Cl. E06B 3/38; E06B 7/16

(52) U.S. Cl. 49/394

(57) ABSTRACT

A window frame assembly includes an outer frame, a pivotable sash and a semi-fixed sash. The outer frame includes a horizontal cross framing member extending across the outer frame. The cross framing member has a top face and a bottom face and a groove extending along the top face. The pivotable sash is pivotable about the bottom rail of the outer frame. The semi-fixed sash is positionable above the cross framing member and includes a bottom rail provided with a main receiving channel in which a locking bar is inserted. The locking bar has a lip projecting downwardly from the bottom rail of the semi-fixed sash for engaging and extending into the groove of the horizontal cross-framing member. A locking mechanism cooperates with the lip and groove to retain the semi-fixed sash within the outer frame in a blocked position and allows its removal in an unblocked position.

### CROSS-REFERENCE TO RELATED APPLICATIONS

This is a continuation-in-part application of application Ser. No. 11/653,943 filed Jan. 17, 2007, which claims priority to Provisional Application Ser. No. 60/759,067 filed Jan. 17, 2006, now expired, the contents of which in their entireties are herein incorporated by reference

### FIELD OF THE INVENTION

The present invention relates generally to the field of windows and window frames. More particularly, it concerns a window frame assembly comprising a semi-fixed sash.

### BACKGROUND OF THE INVENTION

Modern window frames are presently available in a number of different designs and configurations. Casement, awning, picture, single-hung, double-hung, single-sliding, double-sliding, and bay windows each provide their own set of advantages and disadvantages when considering look, functionality and price.

For example, a conventional double-hung window includes two vertically disposed sashes capable of sliding vertically within the larger window frame. A single-hung window similarly includes two vertically disposed sashes, but only one of which is capable of sliding vertically within the window frame. To make opening the window easier, it is typically the upper sash which is fixed in the frame, and the lower sash which can slide vertically.

In a double-hung window, each of the sliding sashes is an articulated sash. An articulated sash is typically equipped with a hinge mechanism allowing it to partially release from the window frame and pivot with respect to the window frame, although other forms of articulation are possible. In use, the upper end of a sliding sash is freed from its vertical track and the sash is allowed to pivot inwards, thereby giving access to the exterior face of each glazing.

This feature allows both interior and exterior faces of double-hung windows to be cleaned from the inside. This can be quite advantageous for windows on the second storey and above, or for windows that are not easily accessible from the outside.

In addition, while double-hung windows are quite complex, they do offer a number of advantages during installation. Because the articulated sashes may be sealed prior to installation within the outer casing, this sealing can be done elsewhere in the building or even offsite. In this way, access to the outer face of the window frame is also granted without having to approach the window from the outside.

For single-hung windows, wherein only the lower sash is openable, it is much more difficult to access the exterior face of the glazing in the upper, fixed sash. In order to do so, one can open the window by sliding the lower sash upwards and reach outside from within in order to wash the window. If hanging out of the window in this manner is not feasible, the washer must approach the window from outside the building. During installation, and in some cases when repairing the window, the window must be approached from the outside to properly access the outer face of the window frame and seal the fixed glazing.

However, single-hung windows have many advantages over double-hung windows. For example, single-hung windows have a much simpler design, which reduces their cost of manufacture and assembly considerably. Because only one sash moves, a single-hung window requires half the track, locking and counter-weighting systems of a double-hung window. A double-hung window can easily cost 20% to 25% more than an equivalently sized single-hung window.

In addition, single-hung windows can be more aesthetically pleasing. From the exterior, they not only allow cleaner lines due to the lack of an outer track, but they require only half the mosquito screen since only half the window opens.

It is important to note that, while this background has thus far focused on hung windows as an example, these same trade-offs are made with respect to other types of windows, such as simple and double sliding windows, or any other configuration which utilises a movable sash and fixed sash in combination where two movable sashes could be used.

Indeed, such trade-offs are more broadly applicable when comparing any type of window frame with a movable sash (hung, sliding, casement, awning, or other) to a fixed frame design. A consumer facing such a choice must similarly consider the low price and simple design of a fixed-frame window in comparison to the convenience and functionality of an articulated sash window.

A previous attempt to solve this problem relates specifically to bay windows formed by a series of tall, thin windows arranged to approximate an arc. In such a series, the two windows at either end of the series are usually crank type windows which employ a crank mechanism, push-rod and pivot assembly to open the window. When opened, however, crank windows only give access to the exterior face of one of their neighbouring windows. Furthermore, if a large number of these tall, thin windows are employed then it becomes quite difficult to reach the central windows from either end.

To provide better access to the exterior faces without significantly increasing the costs, a mock-crank window is installed in the middle of the series which retains the hinge and lock of a crank window, but does not include any of the crank or push-rod assemblies. In this way, the mock-crank windows can open when needed, but not in a controlled manner as provided by the crank and push-rod assemblies.

Thus far, a design has not been produced which can fully make use of the advantages of both the single-type and double-type configurations of various types of windows.

Known in the art are the following U.S. patents which disclose prior art single-hung window frames with removable sashes.

U.S. Pat. No. 6,293,049, issued Sep. 25, 2001 to Shaw, describes a single-hung window comprising a removable upper sash. The window comprises two sash supports fixed to the vertical jambs. A ledge is created between each sash support and the jamb to which it is fixed. This ledge is used to receive a flange which extends downwardly from the lower extremity of the upper sash. In addition, the sash supports include vertical slots which cooperate with corresponding web portions on the upper sash, further solidifying the engagement. The upper sash is removed by lifting it up, within the outer window frame in order to free the flanges from the sash supports.

U.S. Pat. No. 4,831,778, issued May 23, 1989 to Schmidt et al., also describes a single-hung window comprising a removable upper sash. In this design, support pieces are attached to the lower extremities of each stile of the upper sash. Each support piece includes a projection that fits into, and takes a position behind, a notch in a respective vertical jamb. Similarly, the upper sash is removed by lifting it up into an upper recess in the outer window frame in order to disengage the support pieces from the jambs.

Also known in the art are the various disadvantages associated with these types of conventional window frames. For example, such designs can be as complex and difficult to manufacture, and hence expensive, as standard double-hung windows. Moreover, the engagement between the removable upper sash and the outer casing are often too loose to provide adequate sealing against the elements or insulation.

Further known in the art are U.S. Pat. No. 2,509,582, issued Sep. 10, 1948 to Webster, and U.S. Pat. No. 3,122,797, issued Mar. 3, 1964 to Segre, which disclose double-hung windows wherein a sash is provided with downwardly projecting portions which fit into corresponding recesses in their outer casings. Both these patents teach a sash which is removed by lifting it into an upper recess in the outer frame in order to clear the projections from the recesses. The sash is then swung either outwards or inwards from the window frame and removed.

Also known in the art is United States Patent Application No. 2005/0210815, published Sep. 29, 2005, which discloses a window frame operable to receive a removable sash. The outer casing includes a lateral flange which projects inwardly and seals against the sash. Once assembled, the sash is retained within the window frame by a combination of spring flanges and an inner shoulder. The sash can be removed from the outer casing by prying it out of the casing with a sharp blade.

Thus, there remains a need for a window frame which allows easy removal of an a sash in order to access its interior and exterior faces like a double-hung window, but retains the aesthetic advantages and low cost of single-hung window.

Also known in the art are the following patents and published applications which also describe window frames and the like: U.S. Pat. No. 2,865,061, U.S. Pat. No. 2,934,799, U.S. Pat. No. 3,805,452, U.S. Pat. No. 4,283,883, U.S. Pat. No. 4,993,188, U.S. Pat. No. 5,592,781, U.S. Pat. No. 5,918,419, U.S. Pat. No. 6,698,139, U.S. Pat. No. 6,966,158, US 2005/0066582, US 2005/0091926.

### SUMMARY OF THE INVENTION

It is an object of the present invention to provide a window frame that satisfies the above-mentioned need.

According to a first aspect, that object is achieved with a window frame assembly comprising an outer frame, an articulated sash retaining a first glazing and a semi-fixed sash retaining a second glazing. The outer frame includes a pair of vertical frame jambs, a frame header, a frame sill, and a horizontal cross framing member extending across the outer frame. The cross framing member has a top face, a bottom face and a groove extending along the top face. The articulated sash includes an articulating engagement with the outer frame and is operable to open with respect to the outer frame. The semi-fixed sash is positionable above the cross framing member and includes a pair of vertical stiles, a top rail, a bottom rail and a lip projecting downwardly from the bottom rail for engaging the groove, and a locking mechanism co-operable with the lip and groove for retaining the semi-fixed sash within the outer frame.

According to a second aspect, that object is achieved with a window frame assembly comprising an outer frame an articulated sash retaining a first glazing and a semi-fixed sash retaining a second glazing. The outer frame includes a pair of vertical frame jambs, a frame header, a frame sill, and a vertical cross framing member extending across the outer frame. The cross framing member has a side face and a groove extending along the side face. The articulated sash includes an articulating engagement with the outer frame and is operable to open with respect to the outer frame. The semi-fixed sash is positionable beside the cross framing member and includes first and second vertical stiles, a top rail, a bottom rail and a lip projecting outwardly from the first vertical stile for engaging the groove, and a locking mechanism co-operable with the lip and groove for retaining the semi-fixed sash within the outer frame.

As can be appreciated, a window frame assembly according to the present invention can advantageously combine the simplicity and low cost of a single-hung window, and the ease of installation and access to the exterior side of both sashes.

In accordance with a preferred variant, the sills and rails of the semi-fixed sash each have a U-shaped construction formed by an inner wall, a bottom wall and an outer wall. Preferably, the cross framing member comprises a back plate projecting upwardly from its top face. In such a case, the outer wall of the bottom rail abuts against the back plate and the bottom wall of the bottom rail rests on the top face. Preferably again, the lip is part of a locking bar which is insertable within a receiving channel provided in the bottom wall of the bottom rail.

For the sake of clarity, it is worth mentioning that throughout the following description the terms such as inside and outside, inner and outer, and interior and exterior used in relation to the walls or faces of the window frame assembly are defined relative to the interior and exterior of the building embodying the window frame assembly. However, the expressions inner and outer when used in relation to the surfaces of the jambs, header, sill, rails or stiles are defined relative to the central area of the window. Furthermore, the pair of vertical frame jambs, the frame header and the frame sill may be referred to collectively as the “members” of the outer frame.

### BRIEF DESCRIPTION OF THE DRAWINGS

Other objects and advantages of the invention will become apparent upon reading the detailed description and upon referring to the drawings in which:

FIG. 1 is an isometric representation of a window frame assembly in an open position according to an embodiment of the present invention.

FIG. 2 is a detailed view of a cross-section taken along line II-II in FIG. 1, according to a first embodiment of the present invention.

FIG. 3 is a detailed view of a cross-section taken along line II-II in FIG. 1, according to a second embodiment of the present invention.

FIG. 4 is a front view of a window frame assembly in a closed position according to third preferred embodiment of the present invention.

FIG. 5 is a perspective view of an attachment mechanism according to a preferred embodiment of the present invention.

FIG. 6A is an isometric representation of a window frame assembly in a closed position according to a fourth preferred embodiment of the present invention.

FIG. 6B is an isometric representation of the window frame assembly of FIG. 6A, where the pivotable sash is partially opened.

FIG. 6C is an isometric representation of the window frame assembly of FIG. 6A where the pivotable sash is partially opened and the semi-fixed sash is removed.

FIG. 7 is an exploded view of the semi-fixed sash of FIG. 6A.

FIG. 8A is a side view of the bottom rail of the semi-fixed sash of FIG. 6A.

FIG. 8B is a cross section view of the bottom rail of FIG. 8A taken along lines B-B, where the weather-stripping of the outer wall of the semi-fixed sash is a fin seal.

FIG. 8C is a cross section view of the bottom rail of FIG. 8A taken along lines C-C, where the weather-stripping of the outer wall of the semi-fixed sash is a tension seal.

FIG. 9 is an isometric view of the locking bar of the window frame assembly of FIG. 6.

FIG. 10A is a side view of the angle bracket of the semi-fixed sash of FIG. 6, while FIG. 10B is an isometric view of the same angle bracket.

FIG. 11A is a side view of the locking mechanism of the window assembly of FIG. 6, in the original locking position. FIG. 11B is a side view of the locking mechanism in a forced unlocking position. FIG. 11C is an isometric view of the locking mechanism of FIG. 11A.

FIG. 12A is an enlarged broken view of the window assembly of FIG. 6A, while FIG. 12B is an isometric view of a reinforcing pin.

While the invention will be described in conjunction with exemplary embodiments, it will be understood that these are not intended to limit the scope of the invention to such embodiments. On the contrary, the invention is intended to cover all alternatives, modifications and equivalents as may be included as defined by the appended claims.

### DESCRIPTION OF PREFERRED EMBODIMENTS

In the following description, similar features in the drawings have been given similar reference numerals and in order to lighten the figures, some elements are not referred to in some Figures if they were already identified in a preceding Figure.

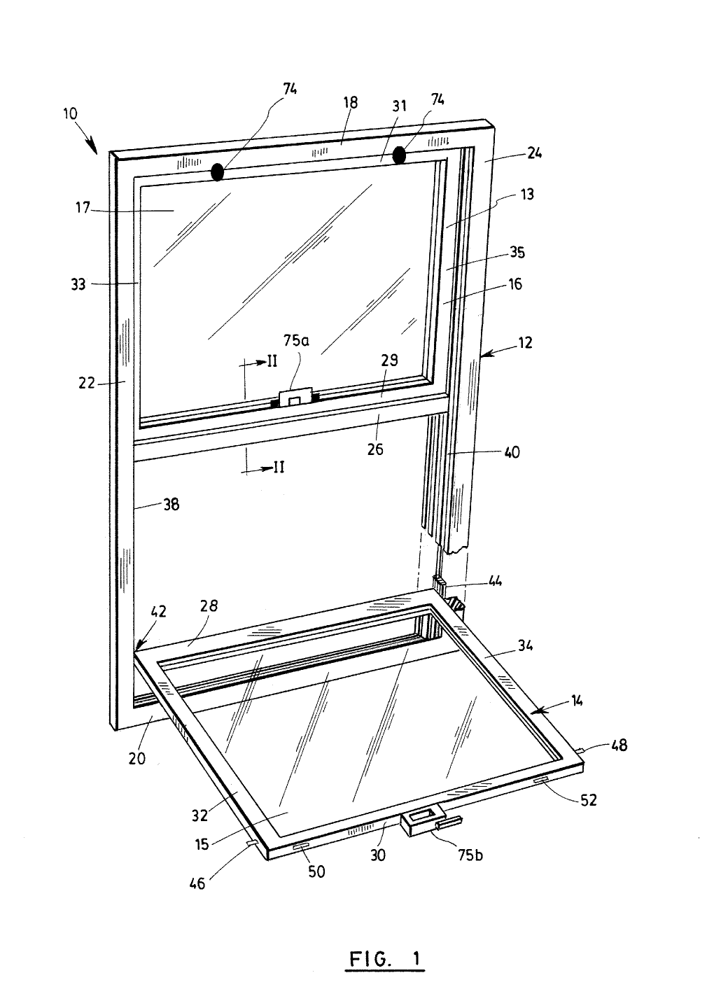

In FIG. 1, a window frame assembly 10 is illustrated comprising an outer frame 12 which retains a lower, articulated sash 14 and an upper, semi-fixed sash 16. The outer frame 12, also called a casing, is installed in a building wall (not shown). It comprises a frame header 18, a frame sill 20, and left and right vertical frame jambs 22 and 24, which form its upper, lower, left and right sides, respectively. A horizontal cross framing member 26, also called a crossbar, is further provided which extends across the casing 12. The articulated sash 14 comprises a bottom rail 28, a top rail 30, and left and right vertical stiles 32 and 34. The semi-fixed sash similarly comprises a bottom rail 29, a top rail 31, and left and right vertical stiles 33 and 35. The sashes 14 and 16 each comprise a transparent pane, such as a first glazing 15 and a second glazing 17. The glazings 15 and 17 generally divide the assembly 10 into an interior side which faces the interior of the building and an exterior side which faces the exterior of the building. FIG. 1 illustrates generally the interior side of the assembly 10, however because the articulated frame 14 has been swung inwards it is its exterior side which is shown.

The semi-fixed sash 16 is positioned in a semi-fixed sash receiving portion 13 formed between the frame header 18, the left and right jambs 22 and 24 and the crossbar 26. It generally remains fixed in the receiving portion 13, although because of its engagement with the casing 12, it can be easily removed for cleaning or repair purposes, or the like, as will be discussed in further detail below. As with most conventional hung windows, the articulated sash 14 is operable to translate vertically within the frame 10 along a pair of tracks 38 and 40 which extend vertically along the inner surfaces of the left and right jambs 24, in front of the crossbar 26 and semi-fixed sash 16. When the articulated sash 14 is slid into its uppermost position and the overlap between the sashes 14 and 16 and their respective glazings 15 and 17 is thereby maximised, the window frame assembly 10 is considered to be fully open with respect to the casing 12.

In order to maintain the vertical position of the articulated sash 14, a counterweight system is provided within the left and right jambs 22 and 24. Such systems are generally known in the art and will not be discussed here in further detail.

In addition, the articulated sash 14 can be swung inwards, as is also common in conventional hung windows. The sliders 42 and 44 are pivotally attached to the articulated sash 14, thereby further enabling the sash 14 to pivot with the respect to the casing 12.

A pair of release pins 46 and 48 are provided in proximity to the upper rail 30. The release pins 46 and 48 work in conjunction with the sliders 42 and 44 to keep the articulated sash 14 within the casing 12. The pins 46 and 48, which project laterally from the intersections of the upper rail 30 and left and right stiles 32 and 34, are also operable to engage the vertical tracks 38 and 40. The pins 46 and 48 are linked internally with a corresponding pair of release tabs 50 and 52 that are located on the upper surface of the upper rail 30. They enable a user to retract the pins 46 and 48, thereby freeing them and the upper end of the articulated sash 14 from the tracks 38 and 40.

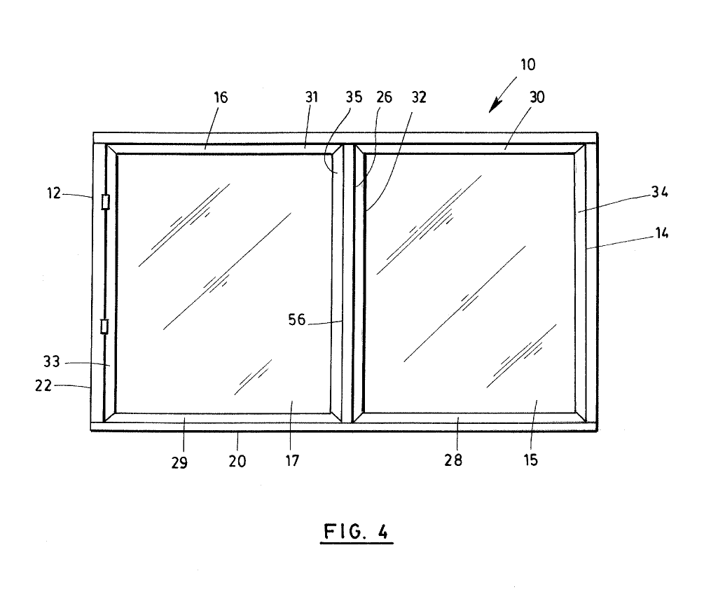

As will be apparent to one of ordinary skill in the art, the precise manner of articulation of the articulated sash 14 described hereinabove is not to be considered limiting. Rather, the articulated sash 14 may be considered to encompass any other conventional sash which is operable to translate, rotate or otherwise change position with respect to the casing 12. Indeed, it is important to note that, while this description has thus far used hung windows as an example, other types of windows, such as simple and double sliding, casement, and awning windows are within the scope of the invention. More specifically, it will be apparent to one of ordinary skill in the art that the structure which enables the vertical translation of a hung window can be quite easily adapted to enable the horizontal translation of a sliding window, as will be discussed in further detail in connection with FIG. 4.

If the window frame assembly 10 were a conventional double-hung window, the upper sash 16 would necessarily comprise an equivalent system of sliders, release pins and release tabs to enable it to perform the same vertical sliding and inward pivoting articulation as described above with respect to articulated sash 14. Were the window frame assembly 10 a single-hung window, the upper sash 16 would simply be fixed in place. In such a case, the lower rail 28, the upper rail 30, the left and right stiles 32 and 34 of the upper sash 16 would be integral parts of the casing 12.

When retained in the casing 12, the semi-fixed sash 16 is positioned within the receiving portion 13 so that it rests on the crossbar 26. A locking mechanism 74 is provided on the interior side of the casing 12 for helping retain the semi-fixed sash 16 in place, as illustrated in FIG. 1. Preferably, the locking mechanism 74 is a pair of tabs located along the header 18 of the casing 12. These tabs 74 are attached to the casing 12 so as to rotate about an axis perpendicular to the plane of the window frame assembly 10. The tabs 74 each comprise an eccentric portion extending away from this axis. By rotating the tabs 74 such that they extend over the top rail 30 of the semi-fixed sash 16, the upper portion of the semi-fixed sash 16 may be blocked from travelling inwards while the frame 12 itself blocks the semi-fixed sash 16 from travelling outwards by a back plate 54 discussed in further detail below. Additional elements of the window frame assembly 10 are then used to further engage and retain the bottom rail 29 of the semi-fixed sash 16, which will be discussed in further detail below. With the semi-fixed sash 16 retained by the tabs 74, the articulated sash is free to translate freely along the tracks 38 and 40.

When the window assembly 10 is fully closed, the articulated sash 14 is fully upright, the release pins 46 and 48 are in engagement with the tracks 38 and 40, the articulated sash 14 is in its bottommost position within the casing 12, and the semi-fixed sash 16 is held within the receiving portion 13. The bottom rail 29 of the semi-fixed sash 16 and the top rail 30 of the articulated sash 14 include complementary portions 75a and 75b of a sash lock for retaining the articulating sash 14 in the fully closed position and thereby securely locking the window assembly 10 from the inside. The sash lock 75a and 75b is preferably a standard sash lock, as would be used on a conventional single-, or double-hung window.

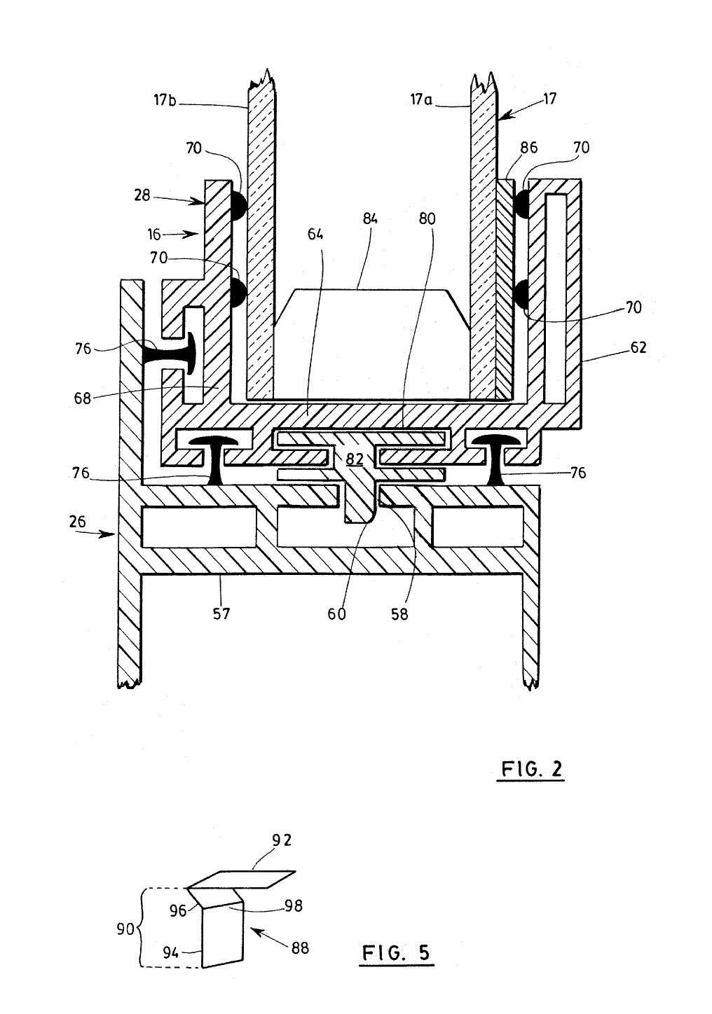

With reference now to FIG. 2, the crossbar 26 comprises a top face 56 upon which the semi-fixed sash 16 sits, a bottom face 57, a back plate 54 projecting upwardly from the top face 56, and a groove 58 which opens along the top face 56 and extends between the top and bottom faces 56 and 57. The bottom rail 29 of the semi-fixed sash 16 is U-shaped and is formed by an inner wall 62, a bottom wall 64 and an outer wall 68. These three walls combine to retain the lower edge of the second glazing 17.

The bottom wall 64 comprises a receiving channel 80 which receives and retains a locking bar 82 comprising a downwardly extending lip 60. When the semi-fixed sash 16 is within the receiving portion 13, the lip 60 is aligned with the groove 58 and fits therein, the bottom wall 64 of the sash 16 sits on the top face 56 of the crossbar 26, and outer wall 68 rests against the back plate 54. The fit between the sash 16 and the semi-fixed sash receiving portion 13 is close enough to allow for a minimal amount of movement therebetween and a proper insulation, while allowing an ease of entry and exit of the sash 16.

Seals 70 are provided between the inner and outer rail walls 62 and 68 and the glazing 17, as is known in the art. The glazing 17 is a thermally insulated window comprising two panes 17a and 17b which are separated by a spacer 84.

In order to ensure a proper insulation, weather-strippings 76 are provided on the semi-fixed sash 16. Preferably, at least one of the weather-strippings 76 is provided extending downwardly from the bottom wall 64, and outwardly from the outer wall 68. More preferably, a downwardly extending weather-stripping 76 is located on either side of the receiving channel 80 and locking bar 82.

While only the lower rail 28 has been shown in cross-section, it is preferable that the construction of the upper rail 30 and the left and right stiles 32 and 34 be equivalent. It is also preferable that the construction of the remaining members of the casing 12, or more particularly the sash receiving portion 13, be similarly equivalent to that illustrated in FIG. 2 inasmuch as they include back plates 54 and top faces 56 for engaging similarly equivalent weather-stripping 76 and sealing the window assembly 10. In addition, it is a back plate 54 extending downwardly from the frame header 18 which works in conjunction with the tabs 74 to secure the top rail 31, as referred to above.

The locking bar 82 and groove 58, however, need only be provided along one of the four sides of the sash 16 and the sash receiving portion 13.

It is worth noting here that the relative positions of the locking bar 82 and the locking mechanism 74 are not accidental. In order to cooperate most effectively to retain the semi-fixed sash 16 within the receiving portion 13, the locking bar 82 and locking mechanism 74 are preferably located opposite one another on the sash 16 and the casing 12. As such, were the locking bar 82 and corresponding groove 58 located along the left stile 22 and left jamb 33 then the locking mechanism would preferably be located on the right jamb 24 in order to engage the right stile 35. Such arrangements are not, however, essential to the functioning of the window frame assembly 10 and other arrangements and types of locking mechanisms are within the scope of the invention.

The inner wall 62 of any or all of the rails 29 and 31 and the stiles 33 and 35 are preferably operable to receive window accessory elements, such as handles, buttons, connectors, locks, or sensors. This reception is preferably assisted by providing a double layered inner wall 62 comprising a void space 72. As such, elements such as these can be affixed via, for example, screws, bolts, adhesive, pegs, or other conventional fixing means to the inner wall 62.

In this manner, semi-fixed sash 16 is not articulated like sash 14 (i.e. it cannot slide vertically, nor can it be pivoted inwards). However, semi-fixed sash 16 can be removed from casing 12 when needed (for example, for cleaning or during installation and repair). In addition, the window frame assembly 10 maintains all of the aesthetic advantages associated with single-hung windows, but only costs approximately 5% more.

Furthermore, a strengthening strip 86 may be disposed within the semi-fixed sash 16. Because of the simple U-shaped design of the lower rail 28 (and, similarly, the upper rail 30, and the left and right stiles 32 and 34), the strengthening strip 86 may be provided to further strengthen and rigidify the semi-fixed sash 16. The strengthening strip 86 can be formed from a metal or denser plastic, and is preferably provided all the way around the semi-fixed sash 16. As illustrated in FIG. 2, the strengthening strip 86 is disposed between the glazing 17 and the inner wall 62. In an alternate embodiment, a strengthening strip can be inserted into the receiving channel 80. The stiffness of the strengthening strip 86 can be increased by providing a bead which is either moulded or rolled along its length, as is known in the art.

Preferably, a pair of grooves 58 are provided, each groove 58 extending approximately two inches in length and located approximately two inches from either jamb 22 and 24 along the top face 56. Correspondingly, a pair of locking bars 82 are preferably provided, each locking bar 82 being dimensioned and aligned in accordance with a respective groove 58. The locking bars 82 may be force fit and/or glued into position along the receiving channel 80.

While the members of the semi-fixed sash 16 are readily manufactured from extruded plastic, such as polyvinyl chloride (commonly known as PVC), in the form illustrated in cross-section in FIG. 2, the remaining elements of the window frame assembly 10, notably the articulating sash 14, the casing 12 and the crossbar 26, can be fabricated from standard, pre-existing single-hung window designs and dies. From a manufacturing perspective, this is enormously beneficial as moulds and dies for PVC window frames can cost in the millions of dollars.

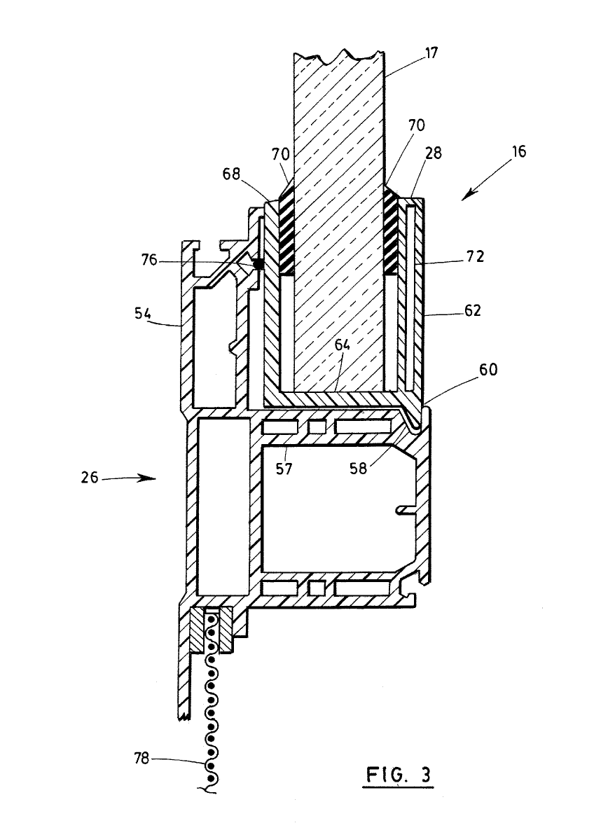

With reference now to FIG. 3, an alternative embodiment of the present invention is illustrated. In this embodiment, the lip 60 extends downwardly from the bottom wall 64 of the bottom rail 29, substantially an extension of the inner wall 62. The lip 60 may also extend the length of the bottom rail 29. Correspondingly, the groove 58 is aligned with the lip 60 along the interior of the top face 56 of the crossbar 26. In this alternate embodiment, a groove normally used with fixed glazing windows can be advantageously be utilised. In conventional fixed-frame designs, glass beads are used to retain the glazing in the frame. The glazing is assembled in a frame of similar construction to the crossbar 26 illustrated in FIG. 3, and four glass beads (assuming a standard, rectangular window) are forced into grooves located along the header, sill and jambs of the frame in order to lock the glazing in place. This glass bead groove can be used to receive the lip 60, therefore once again enabling the use of pre-existing designs and moulds.

In this case, the weather-stripping 76 is provided extending inwardly from the back plate 54 to seal against the outer wall 68.

Lastly, a screen 78 is housed below crossbar 26. The screen 78 can serves to keep insects and animals from entering through the window frame assembly 10 when the articulated sash 14 is in an open position. The screen 78 is removable from window frame assembly 10 in the conventional manner, such that it can be stored when not needed.

As noted above, the above-described window frame structure is also applicable to other types of window frame assemblies, for example a sliding-type window frame assembly 10 as illustrated in FIG. 4. As in the previous embodiment, a semi-fixed window frame assembly comprises a casing 12 which retains an articulated sash 14 and a semi-fixed sash 16. The casing 12 comprises a frame header 18, a frame sill 20, left and right vertical jambs 22 and 24, and a vertical crossbar 26. The articulated sash 14, which is operable to open with respect to the casing 12 by sliding horizontally within the casing 12, comprises a bottom rail 28, a top rail 30 and left and right vertical stiles 32 and 34. The semi-fixed sash 16 comprises a bottom rail 28, a top rail 30 and left and right vertical stiles 32 and 34. In this embodiment, however, a lip 60 (not show) is provided along the right stile 35 and engages the groove 58 (also not shown) in a side face 56 of the crossbar 26. Accordingly, the locking mechanism 74 is located along the left jamb 22 and engages the left stile 33.

In addition, the rails 29 and 31, and stiles 32 and 34 can be mechanically fastened to form the semi-fixed frame 16, due to their simple, U-shaped design, further reducing the cost. For example, an optional attachment mechanism 88 is illustrated in FIG. 5 and comprises a first tang 90 and a second tang 92. The first tang 90 further comprises a first portion 94 and a second portion 96, divided along a bend 98. The attachment mechanism 88 is preferably made of bent sheet metal. Other, conventional mechanical fastening devices, methods and materials may also be used.

During assembly, two adjacent members (i.e. a stile and a rail) of the semi-fixed sash 16 are aligned at 90° to one another. The first portion 94 of the first tang 90 is slid into the receiving channel 80 of one of the two members, which is slightly larger than the width of the first tang 90, up to the bend 98. The second tang 92 is then slid into the receiving channel 80 of the remaining member. A force is then applied to attachment mechanism 88, for example by hammer, in direction 100 to the second portion 96 of the first tang 90. The first tang 90 is thereby unbent so that the first and second portions 94 and 96 are now co-planar. This process is repeated for each of the four corners of semi-fixed sash 16, thereby fixedly retaining the glazing 17. The attachment mechanism 88 may be used alone or in conjunction with an adhesive.

The semi-fixed sash 16 trades the ability to translate and open inwards of an articulated sash, which require a far more robust construction, for the frugal construction taught above all the while providing a window assembly 10 which overcomes many of the difficulties and drawbacks associated with single-hung windows.

Such a construction, enabled by the simple, U-shaped design of the semi-fixed sash 16, is in sharp contrast to that of articulated sashes, like lower sash 14, which often require much more sizable construction in order to properly ensure sufficient insulation and rigidity. In addition, such frames must be fused together, adding additional labour and manufacturing costs. In addition, the presence of a crossbar 26 not only simplifies design, since it too can be manufactured from existing frame models, but it also results in a window assembly 10 which is more structurally and thermally sound than existing single-hung designs which include removable sashes.

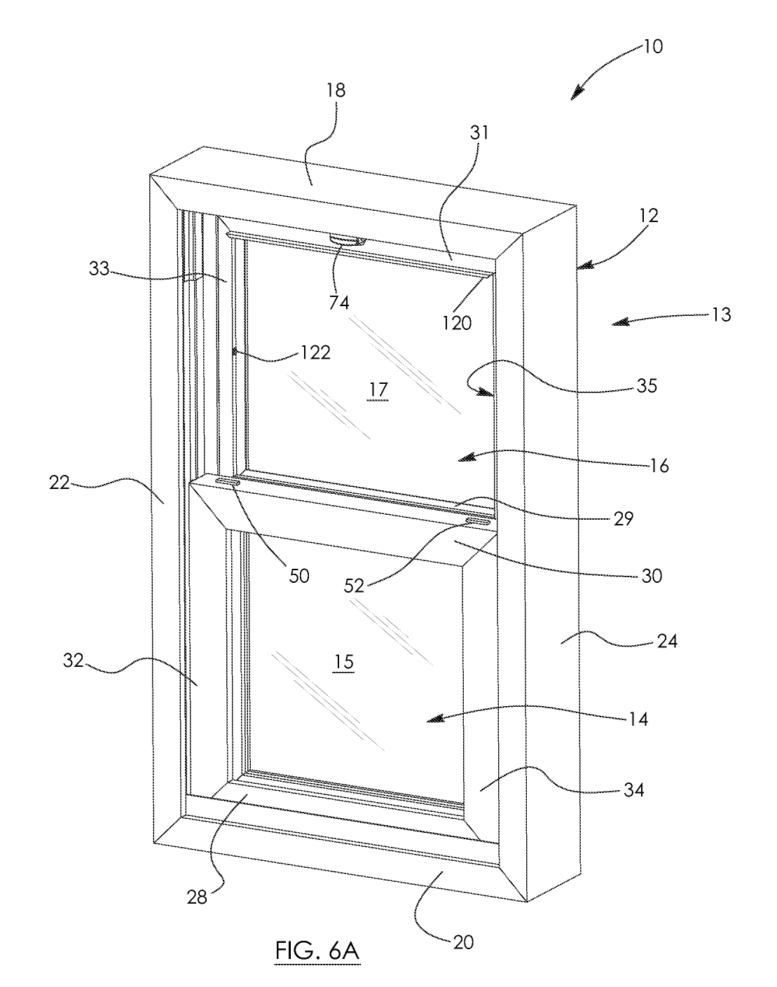

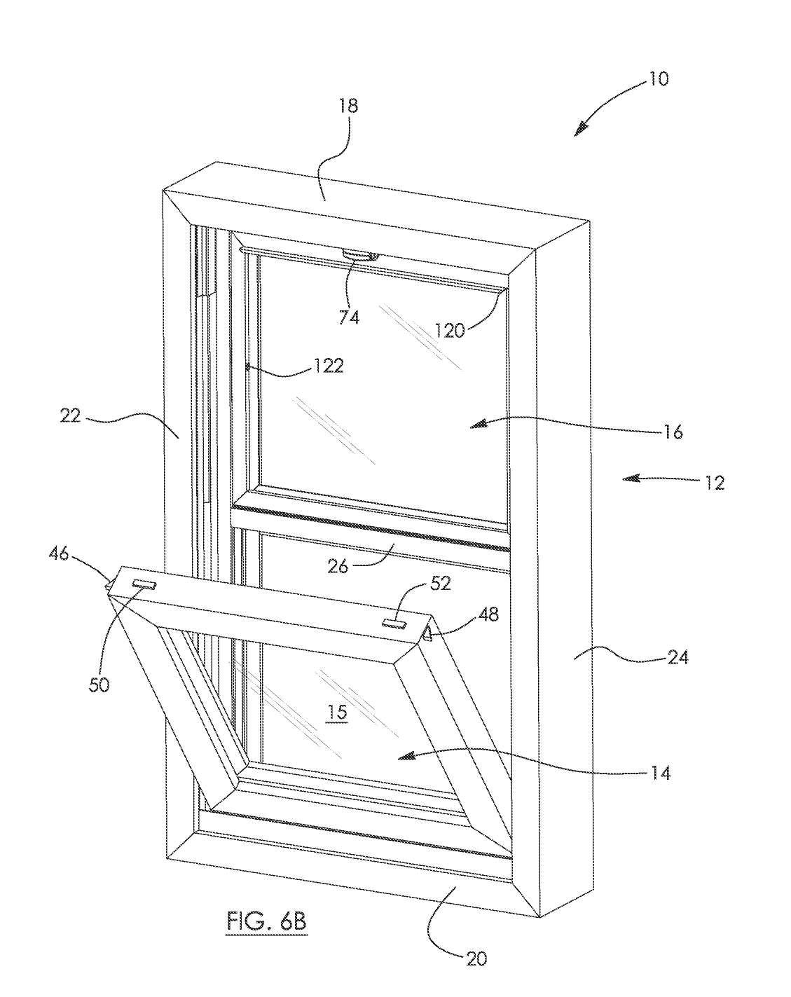

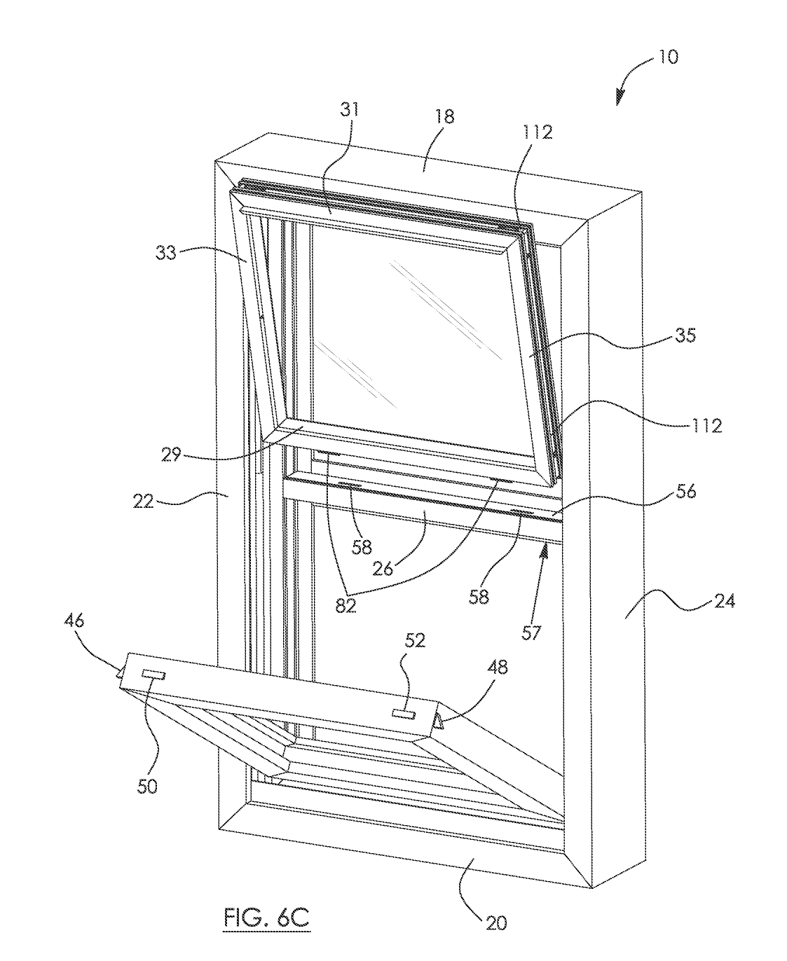

Referring to FIGS. 6A to 6C, a window frame assembly according to another embodiment of the invention is shown. The variant of the window assembly illustrated in FIGS. 6A to 6C includes the same framing elements as the window in FIG. 1. For example, the bottom rail 29 of the semi-fixed sash 16 has a U-shaped construction with a channel 80 for the locking bar and channels for the weather-stripping elements, and the cross-bar 26 is provided with a groove 58. The window assembly 10 includes the semi-fixed window sash 16 and the articulated sash 14, in this case a pivotable, and preferably a slidable, sash 14. By pivotable sash, it is meant that the sash can pivot or be swung inwardly (towards to interior of a building or a house), such as in a hooper window for example.

The window frame assembly 10 of FIGS. 6A to 6C is slightly different form the window frame of FIG. 1 in that it comprises another type of a locking mechanism 74; a locking bar 82 with a slightly different shape; angle brackets 112 at corners of the semi-fixed sash; and reinforcing pins 122 and corresponding holes 124a and 124b in the vertical stiles 33, 35 of the semi-fixed sash 16 and vertical jambs 22, 24 of the outer frame 12 for receiving the pins.

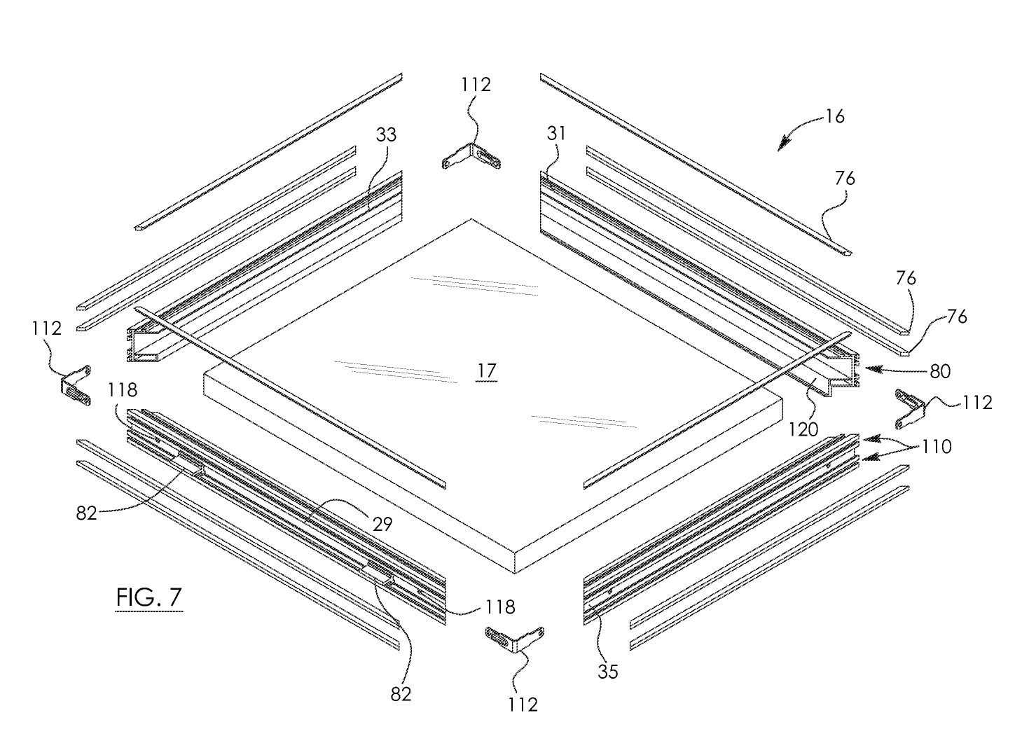

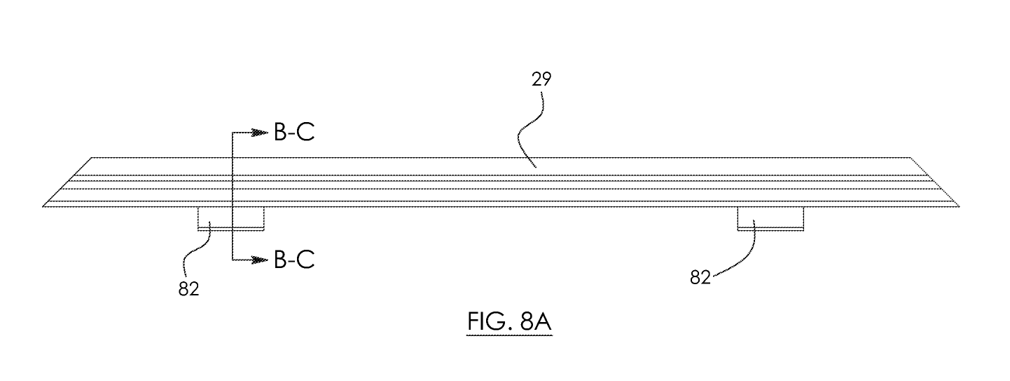

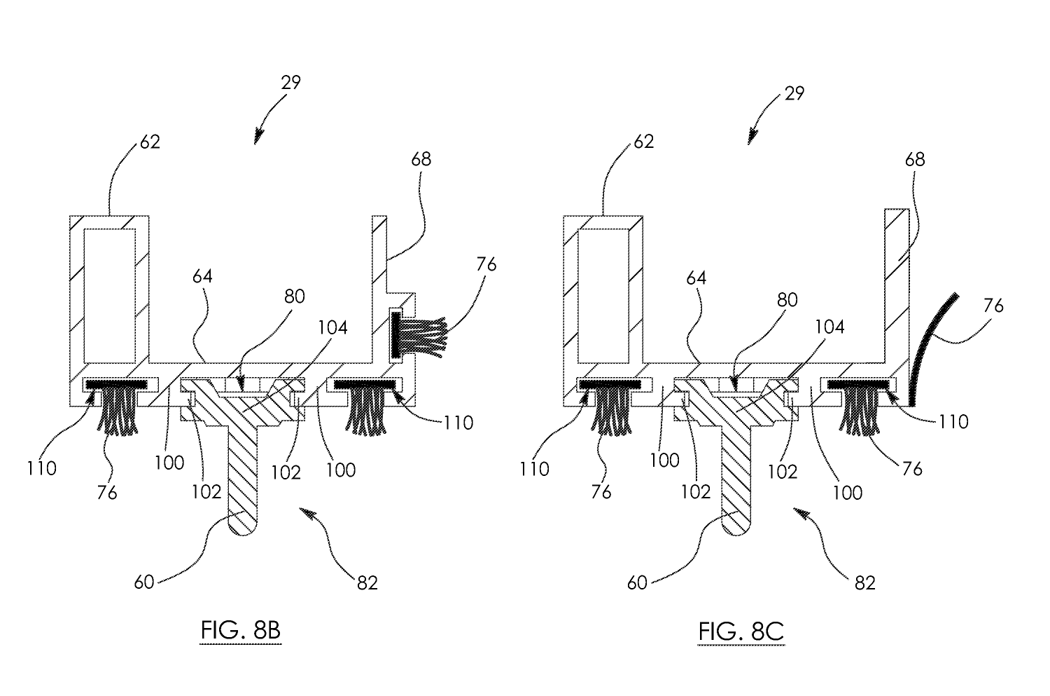

Just as the window assembly 10 of FIG. 1, the outer frame 12 of the variant illustrated in FIGS. 6A to 6C includes the pair of right and left vertical frame jambs 22, 24, the frame header 18 and the frame sill 20. The horizontal cross framing member 26 extends across the outer frame 12 (shown in FIGS. 6B and 6C). The cross framing member 26 includes the groove 58 which extends along the top face 56. By groove 58 it is meant a cut or an opening made through the top face 56 of the cross framing member 26. The lower sash 14 is pivotable between an open position (such as in FIGS. 6B and 6C) and a close position (such as in FIG. 6A) with respect to the outer frame 12. The bottom rail 29 is provided by a main receiving channel 80 (shown in FIGS. 7 and 8B and 8C) for receiving the locking bar 82.

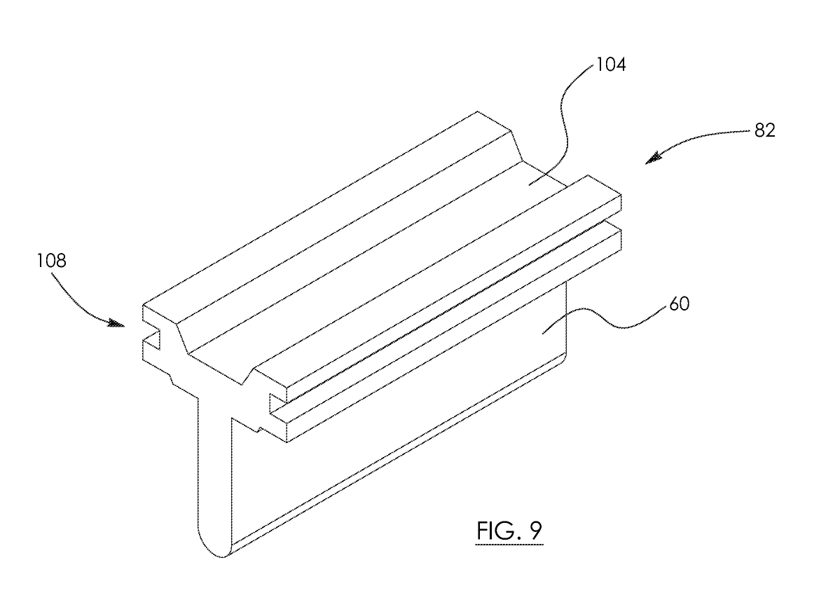

Referring to FIGS. 6C, 7 and FIG. 9, at least one locking bar 82 is inserted within the main receiving channel 80 of the semi-fixed sash 16. Best shown in FIGS. 8A and 9, the locking bar 82 has a lip 60 projecting downwardly from the bottom rail 28 of the semi-fixed sash 16. The lip 60 is for engaging and extending into the groove 58 of the horizontal cross-framing member 26 when the semi-fixed sash is in place within the outer frame 12. In other words, when the semi-fixed sash is blocked within the outer frame 12, it rests on the top face 56 of the cross framing member 16, and the lip 60 of the locking bar 82 is inserted within the groove 58 and extends inside the body of the cross framing member 26, below its top face 56.

As shown in FIGS. 6A to 6C, the locking mechanism 74 is preferably located on frame header 18. Just as in the variant illustrated in FIG. 1, the locking mechanism 74 cooperates with the lip 60 (shown in FIG. 9) and the groove 58 to retain the semi-fixed sash 16 within the outer frame 12. The locking mechanism 74 is manually operable between a closed position in which the semi-fixed sash is blocked within the outer frame (as in FIGS. 6A and 6B), and an open position in which the semi-fixed sash is unblocked and removable from the outer frame (as in FIG. 6C).

The bottom rail 28 of the pivotable sash 14 is slidable upwardly and downwardly with respect the outer frame 12. Such capacity of sliding and pivoting is achieved thanks to sliders 44 (not shown in FIG. 6 but similar to the one illustrated in FIG. 1) connected to the bottom rail of the pivotable sash and inserted within a lower portion of tracks of the vertical jambs 22, 24 of the outer frame 12.

Referring to FIGS. 7, 8B and 8C, the main receiving channel 80 of the semi-fixed sash is formed by the bottom wall 64 of the bottom rail 29 and by two opposed side walls 100, such as the variant illustrated in FIG. 2. Each side walls 100 is provided with an inward rim 102. By inward rims, it is meant that the rims extend over the receiving channel. Preferably, the main receiving channel 80 of the semi-fixed sash 16 extends over the entire length of the rail 29.

Similar to the variant illustrated in FIGS. 1 and 2, the vertical stiles 33, 35 and the top rail 31 of the semi-fixed sash 16 of the variant of FIGS. 6A-6C have the same configuration as the bottom rail 29. By having all the framing elements of the semi-fixed sash sharing the same configuration, manufacturing of the elements is facilitated. For example, if the framing elements are formed by extrusion, a single dye can be used for all four framing elements, which reduces the manufacturing costs. In addition, having all four elements sharing the same configuration provides a lean and simple sash design.

Referring to FIGS. 8B and 8C, and also to FIG. 9, the locking bar 82 preferably has a T-shape cross-section, such as the locking bar 82 illustrated in FIG. 2. The locking bar 82 has a first flange 104 insertable within the main receiving channel 80 of the bottom rail 29 of the semi-fixed sash 16. A second flange extends from the first flange 104 and is substantially perpendicular to the first flange 104. This second flange forms the lip 60 of the locking bar 82. When the semi-fixed sash 16 is in place within the window frame, the second flange 106 enters and extends within the groove 58 of the cross framing element 26.

Referring to FIG. 9, the variant of the locking bar 82 used in the window assembly 10 of FIG. 6 has a first flange 104 with an I-shape. In such configuration, the ends (or sides) of the flange 104 are provided with double ledges. When inserted within the receiving channel, the double-ledged sides are fitted over the rims 102 of the receiving channel 80. In other words, the ledges of the first flange 104 can slide over the rims 102 of the receiving channel 80, and are fixed at the appropriate location on the bottom rail, such that they are aligned with the grooves 58 of the cross bar 26 when the semi-fixed sash is positioned within the window frame 12 (best shown in FIG. 7).

As shown in FIG. 6C, the cross framing member 26 is preferably provided with two grooves extending along the top face of the cross framing member and the bottom rail 29 of the semi-fixed sash 16 is provided with two similar locking bars 82.

Just as the variant of FIGS. 1 and 2, the window assembly 10 of FIG. 6 is provided with weather-stripping elements. As shown in FIG. 7 and also in FIGS. 8B to 8C, the pair of vertical stiles 33, 35, the bottom rail 29 and the top rail 31 of the semi-fixed sash 16 are preferably each provided with two weather-stripping receiving channels 110 extending over their entire length and disposed on each side of the main receiving channel 80. The weather-stripping channels are provided with weather-stripping elements 76, such as felt or fin seal.

Such as the variant illustrated in FIG. 2, the outer walls of the pair of vertical stiles 33, 35, of the bottom rail 29 and of the top rail 31 of the semi-fixed sash 16 of the variant illustrated in FIG. 7 are each provided with a weather-stripping receiving channel extending over their entire length. Again here, the weather-stripping channels are provided with a weather-stripping element 76 extending outwardly from the channels for sealingly engaging a back plate of the cross framing member 26 and an upper portion of the outer frame.

Alternatively, the outer walls of the framing elements 28, 31, 33, 35 of the semi-fixed sash 16 are not provided with weather-stripping channels and their corresponding felt or fin seal weather-stripping, but are rather co-extruded with a weather-stripping element such as a tension seal.

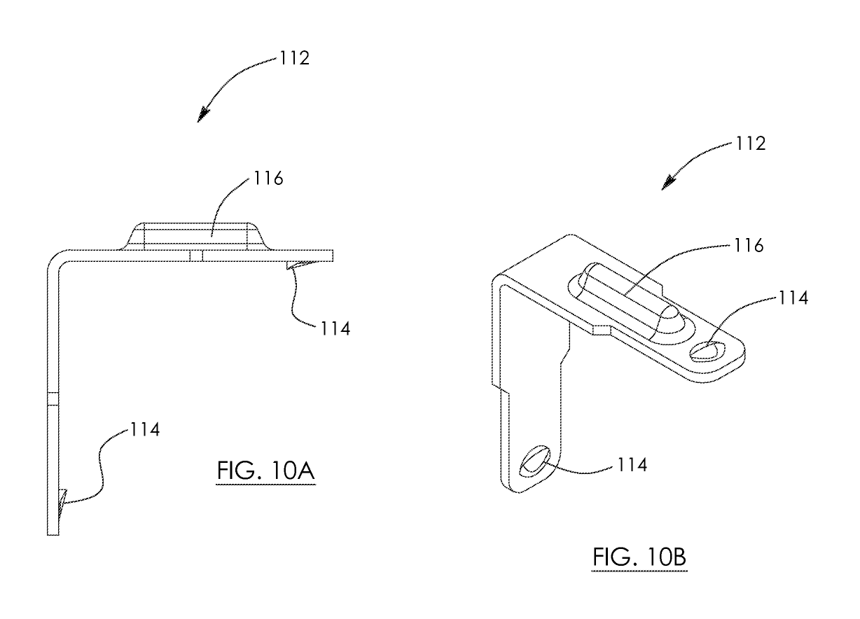

Referring to FIG. 6C, it can be seen that the pair of vertical stiles 33, 35, the top rail 31 and the bottom rail 29 meet at corners of the semi-fixed sash. Now referring to FIG. 7 and also to FIGS. 10A and 10B, the semi-fixed sash includes angle brackets 112 for securing or affixing the corners. The angle brackets 112 have arms extending at right angle and these arms are inserted and locked within the meeting main receiving channels 80 of the corners.

Best shown in FIGS. 10A and 10B, arms of the angle brackets 112 are provided with projecting teeth 114 gripping into corresponding holes 118 (shown in FIG. 7) located near extremities of the pair of vertical stiles 33, 35, the top rail 31 and the bottom rail 28.

In addition, the arms of the angle brackets located on the bottom rail of the semi-fixed sash can be provided with protuberances 116. These protuberances 116 abuts the top face 56 of the cross framing member 26 when the semi-fixed sash is blocked within the outer frame 12 and advantageously supports the weight of the semi-fixed sash 16 in order to prevent any wear of top surface 56 of the cross framing member 26.

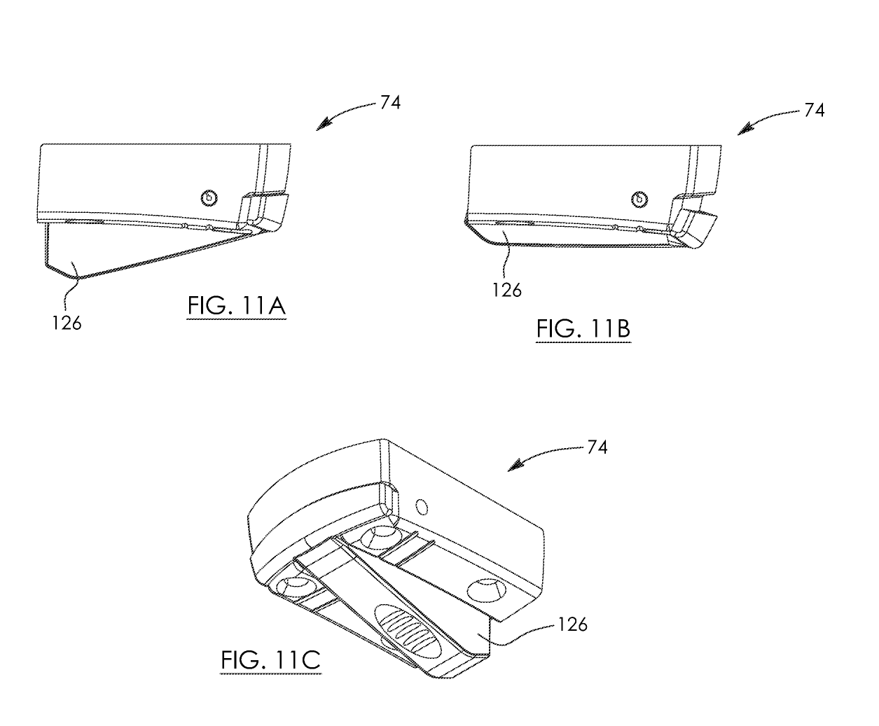

Referring to FIGS. 6A and 6B, the frame header 18 of the outer frame 12 is provided with a locking mechanism 74 as illustrated in FIGS. 11A to 11C. This locking mechanism 74 has a resilient tab 126. In its original or natural locking position, the tab 126 is extended and blocks the top rail of the semi-fixed sash, preventing it to swing inwardly. When forced into its unlocking position, the tab 126 is retracted and releases or frees the top rail 31 and allows removing of the semi-fixed sash 16. In order to remove the semi-fixed sash, a person can press the resilient tab upwardly such that the back of the tab 126 no longer blocks the upper rail 31 of the semi-fixed sash 16. The top rail 31 is preferably provided with a handle bar 122 allowing the person to grab it and swing the semi-fixed sash inwardly to retrieve it from the outer frame 12. The handle 122 facilitates the removal of the semi-fixed sash 16 when the locking mechanism 74 is in the unblocked position.

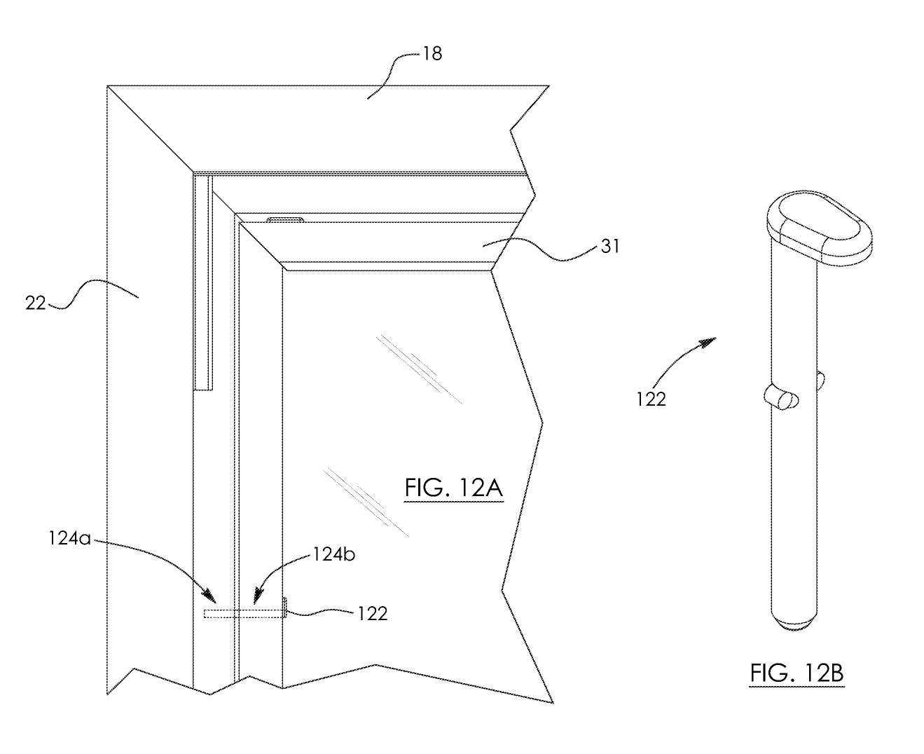

Referring to FIGS. 6A and 6B and also to FIGS. 12A and 12B, the vertical jambs 22, 24 of the outer frame 12 are preferably each provided with a hole 124a aligning with a hole 124b in each of the vertical stiles 33, 35 of the semi-fixed sash 16, when the semi-fixed sash is blocked within the outer frame. A pair of pins 122, for example as illustrated in FIGS. 12A and 12B, can be inserted into these aligned holes 124a,b in order to reinforce the window assembly when the semi-fixed sash is in place and blocked within the window frame 12. The pins 122 also improves the resistance of the window assembly 10 to water or wind infiltrations.

Preferably, the outer frame 12, the vertical stiles 33, 35, the bottom rail 28 and the top rail 31 of the semi-fixed sash 16 and the vertical stiles 32, 34, the bottom rail 20 and the top rail 30 of the pivotable sash 14 are all formed by extrusion.

The preferred embodiments of the window assembly shown in FIGS. 1, 2 and 4, and in FIGS. 6A to 12A all provide the advantage of having a semi-fixed sash with a simple and uncluttered construction which can be easily removed for cleaning or maintenance purposes.

When one wants to ventilate the room where the window assembly 10 is located, the pivotable sash 14 is opened. Release tabs 50,52 located on the top rail 30 of the pivotable sash 14 are pushed towards one another thereby retracting and disengaging the release tabs 46, 48 located on the vertical stiles from the lower portion of the vertical jambs 22, 24 of the outer frame 12. When the release tabs 46, 48 are retracted within the stiles 32, 34 of the pivotable sash 14, the sash 14 can be slid upwardly and then swung inwardly thus creating an opening in the lower section of the window assembly. The pivotable sash 14 can be left slightly opened for ventilating the room. When one wants to clean the outer surface of the glazing 15, the pivotable sash 14 can be pivoted completely downwardly (so that the sash is substantially perpendicular to the outer frame 12) to provide access to the glazing 15.

The semi-fixed window sash 16 is most of the time blocked in place within the window frame. When one wants to clean the outer surface of the glazing 17 of the semi-fixed window sash 16, the window assembly 10 advantageously allows the sash 16 to be manually removed, that is, without using any tools. The pivotable sash 14 must first be slightly opened, to provide enough clearance for the semi-fixed sash 16 to be removed. With the variant illustrated in FIG. 2, the two locking mechanism 74 would be turned to release the top rail 31 of the semi-fixed sash 16. With the variant illustrated in FIG. 6, the resilient tab 126 of the locking mechanism 74 is pressed so that it no longer blocks the top rail 31 of the semi-fixed sash 16. The handle 120 located on the top rail 31 can be grabbed and pulled inwardly so that the sash 16 slightly pivots inwardly about its bottom rail 29. When the top rail 31 is freed from the header frame 18, the semi-fixed sash can be pulled upwardly to disengage the locking bars 82 from the grooves 58 of the cross framing member 26, and the semi-fixed sash is thus removed from the frame 12. The cross framing member 26 stays fixed within the outer frame 12 and the pivotable sash 14 does not need to be removed in order to retrieve the semi-fixed sash 16. The inverse procedure is followed to put the semi-fixed sash 16 back in place within the outer frame 12.

Similar to the variant illustrated in FIG. 2, the window assembly 10 illustrated in FIG. 6A to 6B can also be constructed such that it is shifted by 90 degrees.

The combination of the U-shape construction of framing elements of the outer frame 12, the use of angles brackets 112, the design and location of the weather-stripping elements 76 and the use of reinforcing pins 122 advantageously allows the window frame assembly 10 as illustrated in FIG. 6 to comply with stringent water tightness, air tightness, wind resistance and security norms.

The above description of preferred embodiments of the present invention should not be read in a limitative manner as refinements and variations are possible without departing from the spirit of the invention. The scope of the invention is defined in the appended claim and its equivalents.

1. A window frame assembly, comprising:
a) an outer frame having:
i) a pair of vertical frame jambs, a frame header, a frame sill; and
ii) a horizontal cross framing member extending across the outer frame, the cross framing member having a top face, a bottom face and a groove extending along the top face;
b) a pivotable sash retaining a first glazing, mounted to the outer frame, the pivotable sash including a pair of vertical stiles, a top rail and a bottom rail and being pivotable between an open position and a close position with respect to the outer frame;
c) a semi-fixed sash retaining a second glazing and positionable above the cross framing member, the semi-fixed sash including a pair of vertical stiles, a top rail, a bottom rail, said bottom rail being provided with a main receiving channel;
d) a locking bar inserted within the main receiving channel of the semi-fixed sash, the locking bar having a lip projecting downwardly from the bottom rail of the semi-fixed sash for engaging and extending into the groove, below the top face of the horizontal cross-framing member;
e) a locking mechanism to engage the outer frame and cooperate with the lip and groove to retain the semi-fixed sash within the outer frame, the locking mechanism manually operable between a closed position in which the semi-fixed sash is blocked within the outer frame, and an open position in which the semi-fixed sash is unblocked and removable from the outer frame.

2. The window frame assembly of claim 1, wherein the pair of vertical stiles, the bottom rail and the top rail of the semi-fixed sash each have a U-shaped construction formed by an inner wall, a bottom wall and an outer wall for receiving the second glazing.

3. The window frame assembly of claim 1, wherein the main receiving channel of the semi-fixed sash is formed by a bottom wall and two opposed side walls, each of the side walls being provided with an inward rim.

4. The window frame assembly of claim 3, wherein the main receiving channel of the semi-fixed sash extends over the entire length of the bottom rail.

5. The window frame assembly of claim 2, wherein the pair of vertical stiles and the top rail of the semi-fixed sash are also each provided with a main receiving channel extending over their entire length and located underneath the bottom wall of the U-shape construction, and formed by two opposed side walls, each of the side walls being provided with an inward rim.

6. The window frame assembly of claim 1, wherein the locking bar has a T-shape cross-section.

7. The window frame assembly of claim 1, wherein the locking bar has a first flange insertable within the main receiving channel of the bottom rail of the semi-fixed sash and a second flange substantially perpendicular to said first flange, this second flange forming the lip of the locking bar.

8. The window frame assembly of claim 3, wherein the locking bar has a I-shaped first flange with double ledged sides insertable over the inward rims of the main receiving channel of the semi-fixed sash, and a second flange substantially perpendicular to said first flange, this second flange forming the lip of the locking bar.

9. The window frame assembly of claim 1, further comprising a second groove extending along the top face of the cross framing member and a second locking bar inserted within the main receiving channel of the bottom rail of the semi-fixed sash, said second locking bar having a lip projecting downwardly from the bottom rail for engaging and extending into the second groove.

10. The window frame assembly of claim 2, wherein the cross framing member comprises a back plate projecting upwardly from the top face, and when the semi-fixed sash is blocked within the outer frame, the outer wall of the bottom rail of the semi-fixed sash abuts against the back plate whereas the bottom wall of the bottom rail of the semi-fixed sash rests on the top face of the cross framing member.

11. The window frame assembly of claim 2, wherein the semi-fixed sash comprises at least one weather-stripping element extending downwardly from the bottom wall of the bottom rail of the semi-fixed sash for sealingly engaging the top face of the horizontal cross-framing member.

12. The window frame assembly according to claim 5, wherein the pair of vertical stiles, the bottom rail and the top rail of the semi-fixed sash are further provided with two weather-stripping receiving channels extending over their entire length and disposed on each side of the main receiving channel, each of said weather-stripping channels being provided with a weather-stripping element extending outwardly for sealingly engaging the top face of the cross framing member and an upper portion of the outer frame.

13. The window frame assembly according to claim 10, wherein the outer walls of the pair of vertical stiles, of the bottom rail and of the top rail of the semi-fixed sash are each provided with a weather-stripping receiving channel extending over their entire length, each of said weather-stripping channels being provided with a weather-stripping element extending outwardly, for sealingly engaging the back plate of the cross framing member and an upper portion of the outer frame.

14. The window frame assembly according to claim 10, wherein the outer walls of the pair of vertical stiles, of the bottom rail and of the top rail of the semi-fixed sash are provided with co-extruded flexible weather-strippings for sealingly engaging the back plate of the cross framing member and an upper portion of the outer frame.

15. The window frame assembly of claim 5, wherein the pair of vertical stiles, the top rail and the bottom rail of the semi-fixed sash meet at corners of the semi-fixed sash, and the semi-fixed sash further comprises angle brackets for securing the corners, said angle brackets having arms extending at right angle inserted and locked within the meeting main receiving channels of the corners.

16. The window frame assembly of claim 15, wherein the arms of the angle brackets are provided with projecting teeth gripping into corresponding holes located near extremities of the pair of vertical stiles, the top rail and the bottom rail.

17. The window frame assembly of claim 16, wherein arms of the angle brackets located on the bottom rail of the semi-fixed sash are provided with protuberances for abutting the top face of the cross framing member when the semi-fixed sash is blocked within the outer frame.

18. The window frame of claim 2, wherein the inner walls of the pair of vertical stiles, bottom rail and top rail of the semi-fixed sash is a double layered wall comprising a void space.

19. The window frame of claim 1, wherein the locking mechanism comprises a resilient tab operable between an original locking position wherein the tab is extended and blocks the top rail of the semi-fixed sash and a forced unlocking position wherein the tab is retracted and releases the top rail, thus allowing removal of the semi-fixed sash.

20. The window frame of claim 1, wherein the vertical jambs of the outer frame are provided with a hole aligning with a hole in the vertical stiles of the semi-fixed sash when the semi-fixed sash is blocked within the outer frame and wherein the window assembly further comprises a pair of pins, each pin insertable into the aligned holes for reinforcing the assembly.

21. The window frame of claim 1, further comprising a handle bar located on the inner wall of the top rail of the semi-fixed sash for facilitating removal of the semi-fixed sash when the locking mechanism is in the unblocked position.

22. The window frame assembly of claim 1, wherein the bottom rail of the pivotable sash is upwardly and downwardly slidabe with respect the outer frame.

23. The window frame assembly of claim 22, wherein the bottom rail of the pivotable sash has two ends pivotally connected to sliders slidably inserted within tracks of the vertical frame jambs.

24. A window frame assembly, comprising:
a) an outer frame having:
i) a pair of vertical frame jambs, a frame header, a frame sill; and
ii) a vertical cross framing member extending across the outer frame, the cross framing member having a side face and a groove extending along the side face;
b) a pivotable sash retaining a first glazing, mounted to the outer frame, the pivotable sash including a first and a second vertical stiles, a top rail, a bottom rail and being pivotable between an open position and a close position with respect to the outer frame;
c) a semi-fixed sash retaining a second glazing and positionable beside the cross framing member, the semi-fixed sash including a first and a second vertical stiles, a top rail, a bottom rail, said first vertical rail provided with a main receiving channel;
d) a locking bar inserted within the main receiving channel of the semi-fixed sash, the locking bar having a lip projecting outwardly from the first vertical rail for engaging and extending into the groove, below the side face of the cross-framing member; and
e) a locking mechanism to engage the outer frame and cooperate with the lip and groove to retain the semi-fixed sash within the outer frame, the locking mechanism manually operable between a closed position in which the semi-fixed sash is blocked within the outer frame, and an open position in which the semi-fixed sash is unblocked and removable from the outer frame.

25. The window frame assembly according to claim 24, wherein the outer frame; the vertical stiles, the bottom rail and the top rail of the semi-fixed sash and the vertical stiles, the bottom rail and the top rail of the pivotable sash are formed by extrusion.

26. The window frame assembly according to claim 1, wherein the outer frame; the vertical stiles, the bottom rail and the top rail of the semi-fixed sash and the vertical stiles, the bottom rail and the top rail of the pivotable sash are formed by extrusion.
